(19) United States
(12) Patent Application Publication
(10) Pub. No.: US 2008/0153072 A1
(43) Pub. Date: Jun. 26, 2008

(54) Braille-Information Processing Apparatus, Method of Controlling Braille-Information Processing Apparatus, and Braille Forming Apparatus

(75) Inventor: Hiroyasu KURASHINA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/954,728

(22) Filed: Dec. 12, 2007

(30) Foreign Application Priority Data
Dec. 20, 2006 (JP) 2006-342831

(51) Int. Cl. G09B 21/02

(52) U.S. Cl. 434/114

(57) ABSTRACT

A braille-information processing apparatus includes: a braille pattern converting device that converts input character information into a braille pattern based on a first grade braille description processing rule or a second grade braille description processing rule; and an input environment setting device that sets an input environment to a first grade braille mode based on the first grade braille description processing rule or a second grade braille mode based on the second grade braille description processing rule, wherein the braille pattern converting device converts the input character information into a first grade braille pattern based on the first grade braille description processing rule when the input environment is set to the first grade braille mode, and converts the input character information into a second grade braille pattern based on the second grade braille description processing rule when the input environment is set to the second grade braille mode.

The entire disclosure of Japanese Patent Application No. 2006-342831, filed Dec. 20, 2006, is expressly incorporated by reference herein.

### BACKGROUND

1. Technical Field

The invention relates to a braille-information processing apparatus for converting characters information into braille based on a braille description processing rule, a method of controlling the braille-information processing apparatus, and a braille forming apparatus.

2. Related Art

A character-information-processing apparatus is known in which braille recognizable by visually-impaired people are arranged on a tape and braille embossing is performed thereon, thereby being capable of forming the tape (the braille dedicated tape) recognizable by visually-impaired people. JP-A-2001-88358 is an example of related art. In this case, input characters information is converted based on a braille description processing rule (a braille description processing rule, etc., for English language “alphabets”), and Braille is generated.

However, in braille description processing rules for English language, the first grade braille description processing rule (Grade 1), and the second grade braille description processing rule (Grade 2) are being used. When braille is formed based on the second grade braille description processing rule, a braille former is required to understand the second grade braille description processing rule. Therefore, forming the second grade braille is difficult for people who have little understanding for braille.

### SUMMARY

An advantage of the invention is to provide a braille-information processing apparatus by which even people who have little understanding for braille can properly use the first and the second grade brailles easily, a method of controlling the braille-information processing apparatus, and a braille forming apparatus.

According to a first aspect of the invention, there is provided a braille-information processing apparatus comprising: a braille pattern converting device that converts input character information into a braille pattern based on a first grade braille description processing rule or a second grade braille description processing rule; and an input environment setting device that sets an input environment to a first grade braille mode based on the first grade braille description processing rule or a second grade braille mode based on the second grade braille description processing rule. The braille pattern converting device converts the input character information into a first grade braille pattern based on the first grade braille description processing rule when the input environment is set to the first grade braille mode, and converts the input character information into a second grade braille pattern based on the second grade braille description processing rule when the input environment is set to the second grade braille mode.

According to a second aspect of the invention, there is provided a method of controlling a braille-information processing apparatus which converts input character information into a braille pattern comprising: an input environment setting that sets an input environment to a first grade braille mode in which the input environment is converted to the braille pattern based on a first grade braille description processing rule or to a second grade braille mode in which the input environment is converted to a braille pattern based on a second grade braille description processing rule; and a braille pattern converting that converts the input character information into a first grade braille pattern based on the first grade braille description processing rule when the input environment is set to the first grade braille mode, and that converts the input character information into a second braille pattern based on the second grade braille description processing rule when the input environment is set to the second grade braille mode.

According to these configurations, it is possible to convert input characters information automatically into braille patterns based on a braille description processing rule corresponding to respective braille modes by setting input environment to either one of the first grade braille mode and the second grade braille mode. Accordingly, it is possible for people who have little understanding for braille to properly use the first braille and the second braille easily to form desired braille.

In this case, it is preferable that the braille-information processing apparatus further comprises an indicating device for indicating a braille mode set by the input environment setting device.

According to this configuration, a user can discriminate whether a current braille mode is in the first grade braille mode or the second grade braille mode easily by indicating the set braille mode. The indicating device may be an on/off of a lamp in an indicator, or a character display on a screen. The indicating device may be a sound.

In this case, the braille-information processing apparatus further comprises a file storing device for storing a file including the characters information and braille information generated based on the characters information in a storage unit and a file calling device for calling the file stored in the storage unit. The file storing device further stores the braille mode at the time of file creation as an individual braille mode, together with the file.

According to this configuration, since formed various information is stored as a file and the file can be called, it is possible to reuse braille, etc., which are once formed. Also, since the braille mode at the time of file creation is stored as an individual braille mode, it is unnecessary to manage the file discriminately per braille mode and is easy to manage the file.

In this case, it is preferable that the braille-information processing apparatus further comprises a braille mode setting device that changes the braille mode to the individual braille mode to set when the individual braille mode of the file called by the file calling device is different from the braille mode set before calling for the file.

According to this configuration, in a case in which the formed file is called again, it is possible to set the braille mode set before calling the file to the same braille mode (the individual braille mode) at the time of previous creation. It is possible to perform an operation such as file editing in the same mode as previously, without recognizing the individual braille mode of the file called.

In this case, it is preferable that the braille-information processing apparatus further comprises an editing device that edits the file called by the file calling device. The editing device edits the file based on the braille mode set before calling for the file, regardless of the individual braille mode of the file called, and the file storing device changes the individual braille mode of the file to the set braille mode to store when the individual braille mode of the file called by the file calling device is different from the braille mode set before calling for the file.

According to this configuration, it is always possible to form braille and to edit the file based on the braille mode set at the time. Therefore, the user can perform an operation with only knowing the set braille mode.

In these cases, it is preferable that the braille-information processing apparatus indicates that the individual braille mode is different from the set braille mode or that the braille mode is changed, when the individual braille mode of the file called by the file calling device is different from the braille mode set before calling the file.

According to this configuration, the user can avoid an operation in the unintended mode by indicating at least either one of the braille mode and the change of braille modes in operation.

It is possible to provide a method of controlling the braille-information processing apparatus which is capable of converting the input characters information into the first grade braille or the second grade braille by setting the input environment to the first grade braille mode or the second grade braille mode with the aid described above.

It is preferable that the braille forming apparatus of the invention comprises each device described above in the braille-information processing apparatus and a braille embossing device that braille embosses based on the braille pattern converted by the braille pattern converting device.

According to this configuration, it is possible to provide the braille forming apparatus which is capable of converting the input character information into the first grade braille pattern or the second grade braille pattern by setting the input environment to the first grade braille mode or the second grade braille mode, and of braille embossing.

### BRIEF DESCRIPTION OF THE DRAWING

The invention will be described with reference to the accompanying drawings, wherein like numbers reference like elements.

FIG. 1 is an appearance perspective view of a label forming apparatus with its lid closed according to an embodiment of the invention.

FIG. 2 is an appearance perspective view of a label forming apparatus with its lid open.

FIG. 3 is an explanatory view for six points braille.

FIGS. 4A and 4B are a plan view and a cross sectional view of an embossing unit, respectively.

FIG. 5 is an illustration for explaining the feed of a tape in a braille embossing section.

FIG. 6 is a schematic block diagram of the label forming apparatus.

FIGS. 7A and 7B are diagrams showing braille displays in the first grade braille mode and the second grade braille mode, respectively.

FIG. 8 is an explanatory transition diagram showing change setting procedures of an input environment based on screen displays.

FIG. 9 is an explanatory transition diagram showing procedures for saving a characters information and braille information as a file.

FIG. 10 is a transition diagram showing the first method for a file calling procedure.

FIG. 11 is a transition diagram showing the second method for a file calling procedure.

### DESCRIPTION OF EXEMPLARY EMBODIMENTS

Hereinafter, a braille-information processing apparatus, a method of controlling the braille-information processing apparatus, a program, a storage medium, and a braille forming apparatus according to an embodiment of the invention will be described with reference to the accompanying drawings. In the invention, input characters information can be converted automatically into braille patterns based on a braille description processing rule corresponding to a braille mode by setting input characters information to either one of the first grade braille mode and the second grade braille mode. In the first grade braille mode, input characters information are converted into the first grade braille patterns based on the first grade braille description processing rule (Grade 1). In the second grade braille mode, the input characters information are converted into the second grade braille patterns based on the second grade braille description processing rule (Grade 2). In the first grade braille mode, each character of the input characters information (alphabets) is shown in a corresponding braille one cell. In the second grade braille mode, a contracted English word (abbreviation) is shown if the input characters information is frequently used English word.

The invention will be explained with an example of a braille-information processing apparatus applied to a label forming apparatus for forming a Braille label which is recognizable by visually-impaired people and visually-normal people. In the label forming apparatus, braille recognizable by visually-impaired people and ink characters recognizable by visually-normal people who do not have visual impairments are arranged on a same tape.

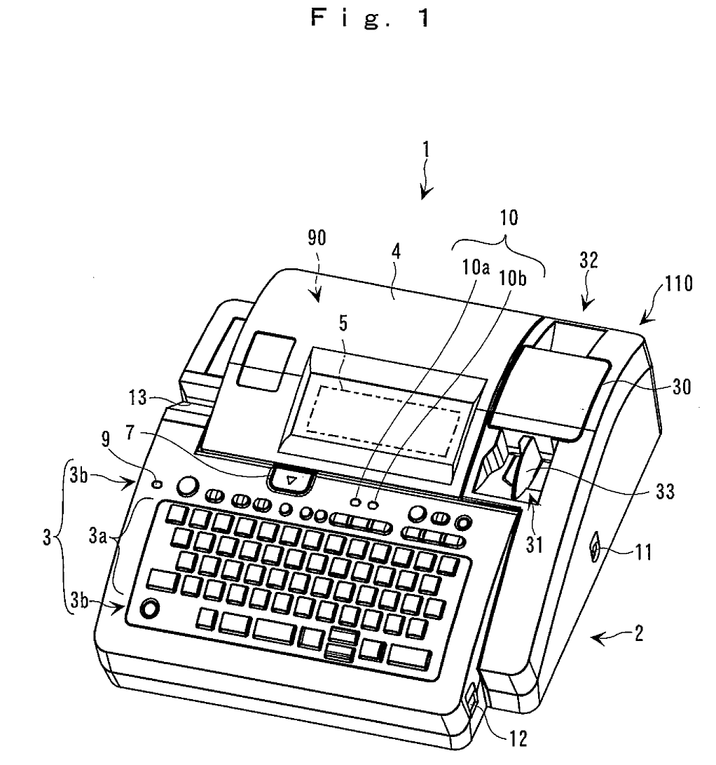

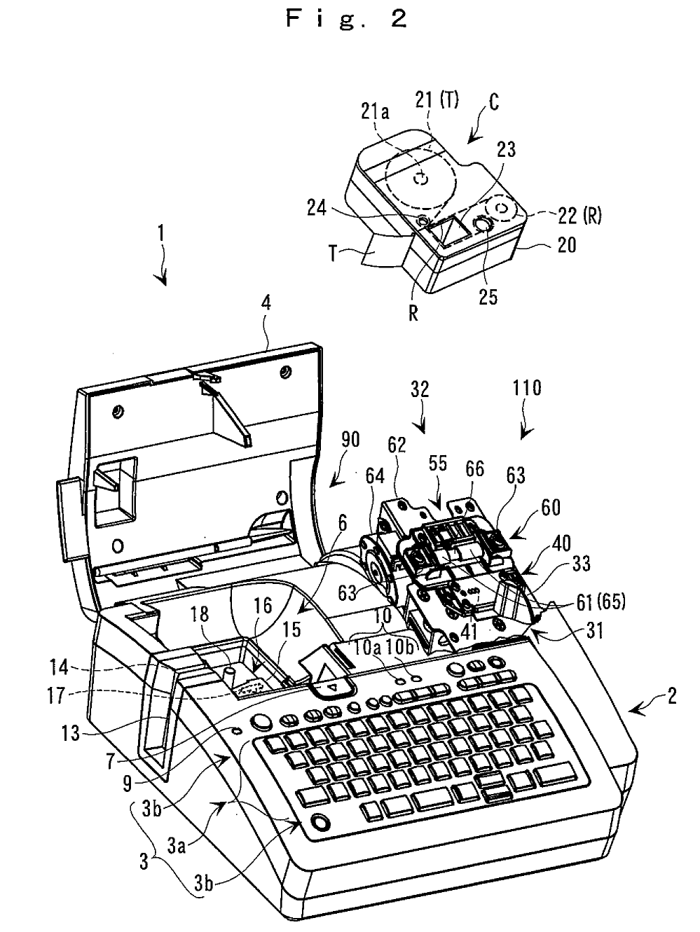

FIG. 1 is an appearance perspective view of a label forming apparatus 1 with its lid closed and FIG. 2 is a perspective view of the label forming apparatus 1 with its lid open. In FIG. 2, a part of an apparatus casing 2 is shown in cutout to show clearly a Braille embossing section 110 performing braille embossing. As shown in FIGS. 1 and 2, the label forming apparatus 1 has an outer shape formed by the apparatus casing 2. The apparatus casing 2 has a front top face having a keyboard 3 thereon, and a rear top face to which an opening/closing cover 4 is attached. Inside the opening/closing cover 4, there is provided an ink-character printing section 90 for performing ink-character printing (i.e., printing of characters such as letters and symbols, etc.) on a tape T paid out from a tape cartridge C, and at the right side of the opening/closing cover 4 (the rear right portion of the apparatus casing 2), there is provided a braille embossing section 110 for performing braille embossing with an insertion of the tape T from the front portion thereof.

The opening/closing cover 4 has a rectangular display 5 on the front side thereof. Inside the opening/closing cover 4 at the left portion thereof, there is provided a recessed cartridge mounting section 6 (the ink character printing section 90) in which the tape cartridge C is mounted. The tape cartridge C is detachably mounted in the cartridge mounting section 6, with the opening/closing cover 4 being opened by depressing a cover opening button 7.

The display 5 is used to display characters information input by a user with the keyboard 3 and six point braille information, and to form/edit ink character data for ink printing and braille data for braille embossing based on the input information. The display 5 also displays various errors and messages (instructions) to warn the user.

On the upper face of the apparatus casing 2, there are provided the key board 3 having various input keys, a power lamp 9 showing a state whether a power is on or off, and an indicator 10 showing a braille mode at the time of braille forming. The key board 3 has a characters key group 3a and a functions key group 3b for designating various operation modes, etc.

The characters key group 3a is used for inputting characters information and is constructed in a full JIS-key arrangement. The characters information means to input information when ink character data for ink character printing and Braille data for braille embossing are formed. Ink character printing and braille embossing can be performed based on the same characters information, and can be performed based on the different characters information.

The functions key group 3b includes “a mode selecting key” for selecting a processing mode, “an executing key” for executing at least an ink character printing process or a Braille embossing process, “a feeding start key” for directing the feed start of the tape T in the braille embossing section 110, “an embossing start key” for starting manual braille embossing, “a braille environment key” for switching to a setting screen for a braille mode, and “a braille transcription key” for converting input information into braille, etc.

The functions key group 3b includes, as in the case of a general word processor, etc., e.g., “a cancel key” for canceling processes, etc., “a cursor key” for moving a cursor, “an up/down (left/right) key” for selecting alternatives in various selecting (designating) screens, and “a decision (selecting break) key” for deciding and for starting a new line at text inputting.

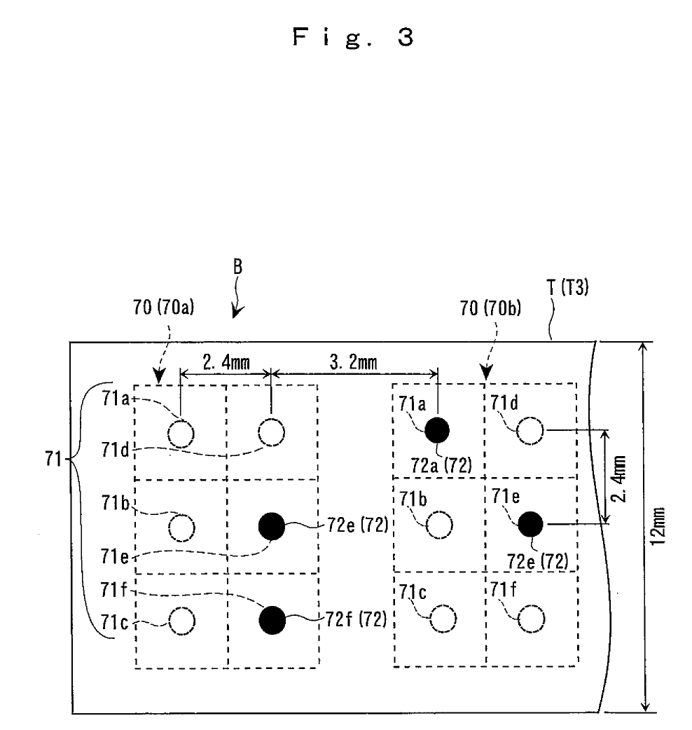

The mode selecting key can select either one of the ink character/braille processing mode: ink character/braille description, the ink character processing mode: ink character only, or, the braille processing mode: braille only. In case of the ink character/braille processing mode, braille embossing process is performed after the ink character printing process. This makes it possible to avoid that a portion of the ink character P printed with an embossing salient 72 (see FIG. 3) formed by embossing can be peeled off if braille embossing is previously performed. In case of the ink character processing mode, the ink character printing process is performed as a general tape printing apparatus, and in case of the braille processing mode, the braille embossing process is performed as a braille embossing apparatus.

The indicator 10 indicating a set input environment is a single color LED (Light Emitting Diode) and includes the first grade braille lamp 10a indicating that the input environment is the first grade braille mode and the second grade braille lamp 10b indicating that the input environment is the second grade braille mode. By turning one of the LEDs on, the set braille mode is indicated. Note that the first grade braille mode is such that input characters information is converted into characters information for the first grade braille and the first grade braille patterns based on the first grade braille description processing rule, and the second grade braille mode is such that input characters information is converted into characters information for the second grade braille and the second grade braille patterns based on the second grade braille description processing rule. These braille modes can be set by the user's selection, thereby braille patterns desired by the user can be formed (details thereof will be explained later).

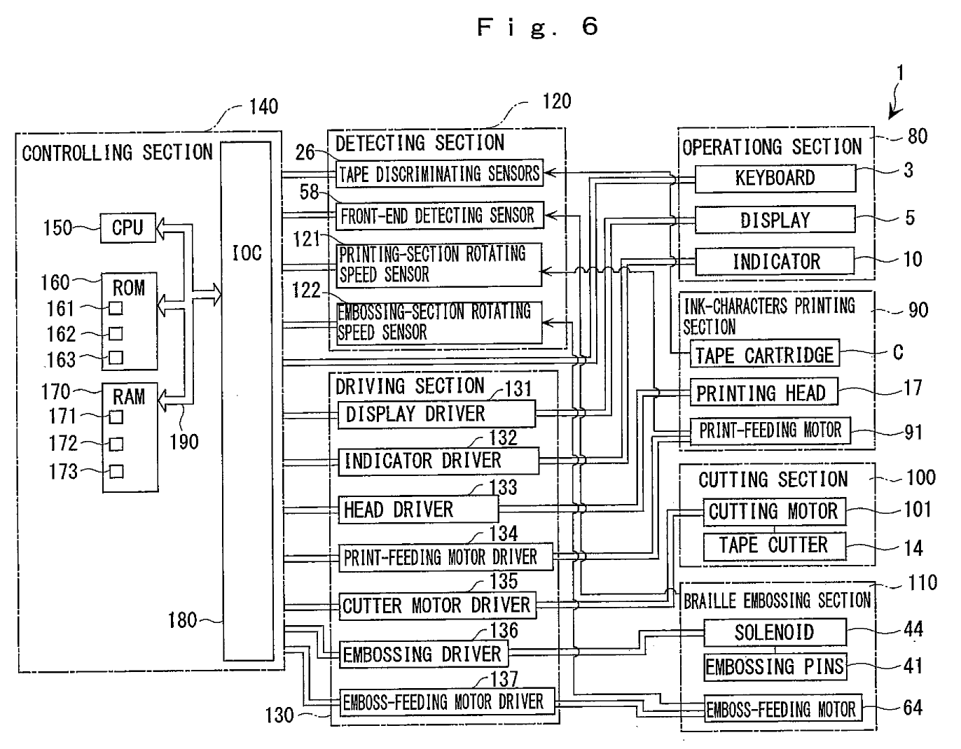

At the center of the apparatus casing 2 on its right side, there is formed a power source supplying port 11 for supplying power. At the front of the apparatus casing 2 on its right side, there is formed a connecting port (interface) 12 for connection with external devices (not shown) such as a personal computer. When the external device is connected to the connecting port 12, it is made possible to print ink characters or emboss braille based on characters information generated by the external device. Furthermore, at the left side of the apparatus casing 2, there is formed a printing-tape ejecting slot 13 for communicating the cartridge mounting section 6 with the outside. At the printing-tape ejecting slot 13, a tape cutter 14 (cutting section 100, see FIG. 6) is arranged to cut off the tape T fed out from the ink-character printing section 90. The tape T printed with ink characters is ejected from the printing-tape ejecting slot 13 cut off by the tape cutter 14.

The configuration around the ink-character printing section 90 (the cartridge mounting section 6) and the braille embossing section 110 will be explained. The cartridge mounting section 6 is provided with: a head unit 16 with a head cover 15 including a printing head 17 composed of a thermal head; a platen driving shaft (not shown) arranged at a position opposite to that of the printing head 17; a reel driving shaft (not shown) for reeling up an ink ribbon R (described later); and a positioning boss 18 for a tape reel 21 (described later). In addition, at the bottom of the cartridge mounting section 6, a print-feeding motor 91 (see FIG. 6) is embedded for rotating the platen driving shaft and the reel driving shaft.

The tape cartridge C has a cartridge casing 20 in which the tape reel 21 reeling the tape T of a constant width at the upper center thereof and a ribbon reel 22 reeling the ink ribbon R at the lower right thereof are accommodated. The tape T and the ink ribbon R have the same width in size. At the lower left of the tape reel 21, there is formed a through hole 23 to be fitted with the head cover 15 covering the head unit 16. Besides, at a position where the tape T and the ink ribbon R overlap each other, there is arranged a platen roller 24 which is driven to rotate by being fitted with the platen driving shaft. Also, a ribbon taking-up reel 25 is arranged adjacent to the ribbon reel 22. The ink ribbon R reeled out from the ribbon reel 22 is taken up by the ribbon taking-up reel 25 in such a manner as to travel around the head cover 15.

When the tape cartridge C is mounted in the cartridge mounting section 6, the head cover 15, the positioning boss 18, and the reel driving shaft are fitted in the through hole 23, the center hole 21a of the tape reel 21, and the center hole of the ribbon taking-up reel 25, respectively. The printing head 17 comes into contact with the platen driving shaft (the platen roller 24) sandwiching the tape T and the ink ribbon R to perform ink-character printing. Then, the tape T printed with ink characters is fed into the printing-tape ejecting slot 13.

The tape T is, not specifically shown, composed of a recording sheet made of resin (for example, a polyethylene terephthalate) whose rear face is provided with an adhesive layer and of a releasing sheet made of resin (for example, a polyethylene/polypropylene polymer) affixed to the recording sheet by the adhesive layer. A printing surface of the recording sheet is fabricated to generate a good condition for an ink by thermal transfer.

The tape T has a plurality of types varying in tape width, tape color, ink color of ink characters, tape material, etc. Therefore, there are provided a plurality of holes (not shown) for discriminating the types of the tape T on the rear face of the cartridge casing 20. In addition, in the cartridge mounting section 6, there are provided a plurality of tape discriminating sensors (micro switches) 26 (see FIG. 6) for detecting the types corresponding to the plurality of holes. In other words, the tape type can be discriminated by detecting the state of the tape discriminating sensors 26.

In the inside of the right upper half of the apparatus casing 2, there is assembled an embossing assembly (the braille embossing section 110) for performing braille embossing. The assembly has an embossing section cover 30 attached to cover the same on the top face thereof. On the near side of the embossing section cover 30 is provided a recessed embossing-tape inserting port 31 into which the user manually inserts (introduces) the tape T. On the back side of the embossing section cover 30 is provided a recessed embossing-tape ejecting port 32 from which the embossed tape T is ejected. Each of the near side and the back side is arranged in such a way as to have a decline along a tape traveling path (a feeding passage) 55. In the vicinity of the embossing-tape inserting port 31, there is provided a manual insertion guide 33 which enables a tape width to be adjusted in a width direction thereof.

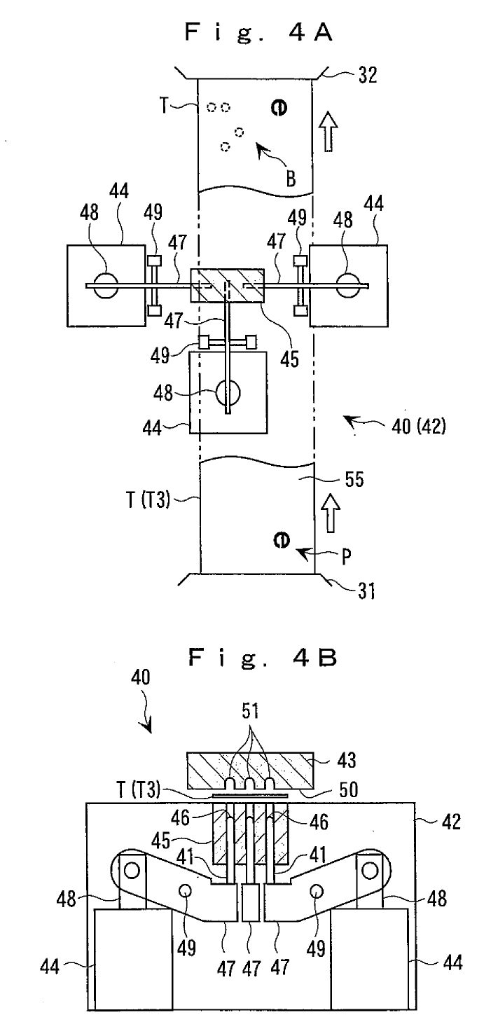

The braille embossing section 110 has an embossing unit 40 in which braille embossing is performed by three embossing pins (embossing heads) 41 (see FIG. 4B), the tape traveling path 55 on which the tape T is transported, and a tape feeding unit 60 which feeds the tape T inserted into the embossing-tape inserting port 31 to the embossing-tape ejecting port 32. These units are assembled in a frame constituting the tape traveling path 55 to constitute the embossing assembly, which is integrally mounted in the apparatus casing 2. The three embossing pins 41 are selectively driven by the embossing unit 40, so as to form braille B on the tape T which is fed along the tape traveling path 55 after the tape feeding unit 60 is driven.

With reference to FIG. 3, braille B (six point Braille B) formed on the tape T (T3: with a tape width of 12 mm) will be explained. FIG. 3 shows braille (braille data) B expressing character information “e”. As shown in FIG. 3, the six point braille B forms one cell 70 constituted of six points (embossing points), which in turn are constituted of three dots in length×two dots in width. This one cell 70 expresses one character or attribution of external font code etc. In other words, braille arrangement is formed with more than two dots in width of three dots in length. In FIG. 3, one cell 70a at the left side is the external font code which shows that the braille B is an alphabet, and the other one cell 70b at the right side shows that the alphabet is “e”.

In the six points braille B, the one cell 70 is divided into six embossing points from 71a to 71f with an arrangement pattern of three dots in length×two dots in width. In the one cell 70a at the left side, two embossing points 71e and 71f out of six embossing points 71a to 71f are selectively embossed, and two embossing salients 72e and 72f (expressing the external font code) are formed on the tape T. In the other one cell 70b at the right side, two embossing points 71a and 71e are selectively embossed, and two embossing salients 72a and 72e (expressing the alphabet “e”) are formed. Six embossing salients 72 have vertical and horizontal pitches between points being approx. 2.4 mm and a pitch to an adjacent cell (between cells) approx. 3.2 mm.

A detailed configuration of the embossing unit 40 will be explained with reference to FIGS. 4A and 4B. FIG. 4A is a plan view showing the embossing unit 40 in FIG. 1 seen from the above, and FIG. 4B is a cross sectional view of the embossing unit 40. FIG. 4A shows that the tape T (with a tape width of 12 mm) printed with ink characters is fed from the embossing-tape inserting port 31 manually via the tape traveling path 55 toward the embossing-tape ejecting port 32.

As shown in FIGS. 4A and 4B, the embossing unit 40 is composed of an embossing member 42 having the three embossing pins 41 and of an embossing receiving member 43 for receiving pushing (embossing) actions caused by the embossing pins 41. A spring (not shown) for absorbing impact is assembled at the back of the embossing receiving member 43.

The embossing member 42 is provided with the three embossing pins 41 arranged at intervals of 2.4 mm along the tape width direction (in the horizontal direction). The three embossing pins 41 correspond to the vertically-arranged three embossing points 71 out of the six embossing points 71, and are held perpendicular to the tape T by a guide member 45 which guides a linear motion of the embossing pins 41 with solenoids 44 as a driving source. Head portions 46 of the embossing pins 41 are formed such that the embossing salients 72 to be embossed have cross sectional shape with its corner rounded such as a cylinder.

Base portions of the embossing pins 41 are connected movably to one ends of arm members 47, respectively. The other ends of the arm members 47 are connected to the tip portions of the plungers 48 of the solenoids 44 (described later) rotatably, and support members 49 are provided which support the intermediate portions of the arm members 47 rotatably. The plungers 48 of the solenoids 44 and the embossing pins 41 are arranged in parallel so that the plungers 48 are linearly moved in the vertical direction with respect to the tape T. Therefore, when the plungers 48 are linearly moved by the solenoids 44, the arm members 47 rotate about the supporting members 49 as a supporting point, thereby causing the embossing pins 41 to move linearly at the back surface of the tape T in a direction perpendicular to the tape T.

The embossing receiving member 43 has three embossing receiving concave portions 51 formed on a face 50 thereof opposite to the three embossing pins 41 for receiving the same. The embossing receiving convex portions 51 are formed as cylinders with rounded corners corresponding to the shape of the head portions 46 of the embossing pins 41.

The embossing pins 41 and the embossing receiving member 43 of the embossing unit 40 form embossing salients 72 on the tape T. In other words, when the solenoids 44 are energized in response to braille data generated based on input information and the plungers 48 are pulled, the embossing pins 41 move in the vertical direction with respect to the tape T guided by the embossing pin guide 45, the embossing pins 41 bump into the corresponding embossing receiving convex portions 51 with the tape T inserted, and the embossing salients 72 are formed on the tape T.

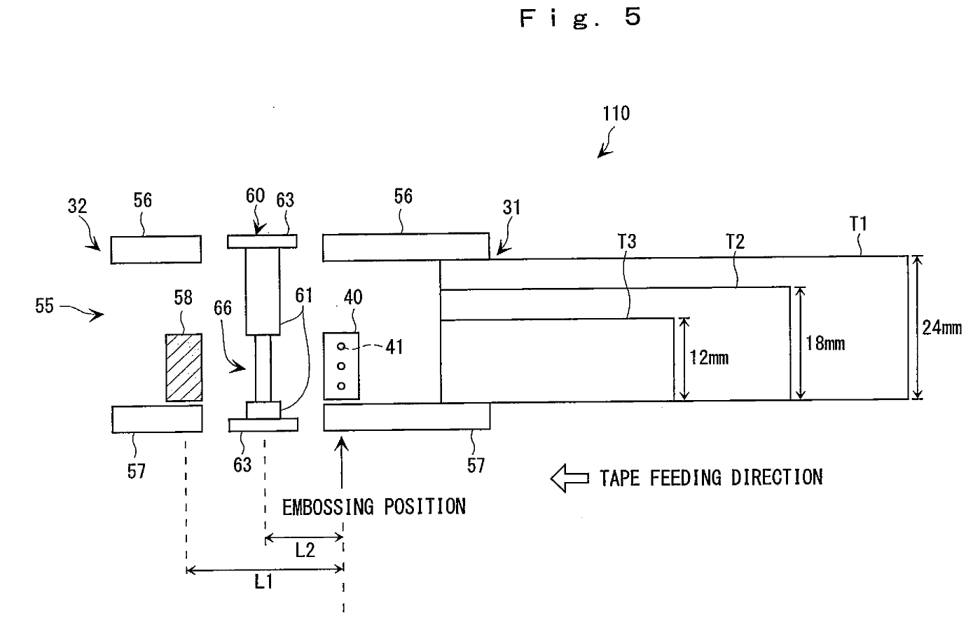

Referring to FIG. 5, a feeding operation for the tape T at the Braille embossing section 110 will be explained. As described above, the Braille embossing section 110 includes the embossing unit 40 forming embossing salients 72 on the tape T with embossing pins 41, the tape traveling path 55 on which the tape T is fed, the tape feeding unit 60 which feeds the tape T along the tape traveling path 55, guide members 56 and 57 to guide the tape feeding on the tape traveling path 55, and a transmission front-end detecting sensor 58 to detect the front-end of the tape T.

The tape feeding unit 60 is composed of: feeding rollers 61; supporting members 63 for supporting the feeding rollers 61 on an apparatus frame 62; and a reversible rotating emboss-feeding motor 64 (see FIG. 6) for rotating the feeding rollers 61. The feeding rollers 61 are composed of grip rollers having driving rollers (not shown) and driven rollers 65 (see FIG. 2). Between the driven rollers 65 is formed an annular groove 66 free from interference from vertical three positions (the positions corresponding to vertically-arranged three embossing points 71 (see FIG. 3), so as to prevent the formed braille B from being crushed.

In the embossing tape feeding port 31, the three types of tapes can be inserted in a decreasing order of tape width, i.e., tape T1 (with a width of 24 mm), tape T2 (with a width of 18 mm), and tape T3 (with a width of 12 mm). The tape T1 with the maximum tape width is guided by the upper and lower guide members 56 and 57, whereas the tapes T2 and T3, each with a smaller tape width than the tape T1, are guided only by the lower guide members 57. For example, when the tape T3 with the minimum tape width is used, the user manually inserts the tape T3 until the front end thereof reaches the tape feeding unit 60 (feeding rollers 61) (up to the furthest possible point of insertion). When the user depresses the “feeding start key” on the keyboard 3, the tape feeding unit 60 starts the feed of the tape T3. Upon detection of the front end of the tape with the front-end detecting sensor 58, a braille embossing process starts (tape feeding and braille embossing based on generated braille data are performed). At this time, when the front margin from the front end of the tape to an embossing start position is set shorter than a length L1 ranging from the embossing unit 40 (embossing pins 41) to the front-end detecting sensor 58 (on the assumption that the front margin is set longer than a length L2 between the embossing unit 40 and the feeding rollers 61 concerning the positions of the feeding rollers 61), the feeding rollers 61 are caused to backlash to feed back the tape T. When the tape T is fed back to an adequate position by a counter rotation, embossing and feeding thereof to a normal direction start.

The user may manually start the Braille embossing process by the embossing unit 40 with depressing “the embossing start key” on the keyboard 3, instead of starting the process after the front end of the tape has been detected by the sensor 58.

Referring to FIG. 6, the label forming apparatus 1 will be described in terms of its' control and configuration. The label forming apparatus 1 is composed of: an operating section 80, an ink-character printing section 90; a cutting section 100; a Braille embossing section 110; a detecting section 120; a driving section 130; and a controlling section 140 which is connected to each of the sections and controls the label forming apparatus 1 overall. The operating section 80 has the keyboard 3, the display 5, and the indicator 10, and serves as a user interface which allows the user to input characters information and to display various information. The ink-character printing section 90 has the tape cartridge C, a printing head 17, and a print-feeding motor (stepping motor) 91, and prints on the tape T ink character while feeding the tape T and an ink ribbon R. The cutting section 100 has a tape cutter 14 and a cutter motor 101 driving therefor, and cuts off the tape T printed with ink characters at a predetermined length. The braille embossing section 110 has solenoids 44, embossing pins 41, and an emboss-feeding motor (stepping motor) 64, and embosses braille on the tape T based on braille data while feeding the same. The detecting section 120 performing various detections has: tape discriminating sensors 26 for detecting the type of the tape T (tape cartridge C); the front-end detecting sensor 58 for detecting the front end of the tape T in the braille embossing section 110; a printing-section rotating speed sensor 121 for detecting the rotating speed of the print-feeding motor 91; and an embossing-section rotating speed sensor 122 for detecting the rotating speed of the emboss-feeding motor 64. The driving section 130 has a display driver 131, an indicator driver 132, a head driver 133, a print-feeding motor driver 134, a cutter motor driver 135, an embossing driver 136, and an emboss-feeding motor driver 137. With such drivers, the driving section 130 drives each of the sections.

The controlling section 140 has a CPU 150, a ROM 160, a RAM 170, and an input/output controller (hereinafter referred to as IOC: Input Output Controller) 180, all of which are connected to one another through an internal bus 190. The ROM 160 has a control program block 161, a control data block 162, and a user data block 163. The control program block 161 stores control programs for controlling various processes including ink-characters printing process or braille embossing process, etc., with the CPU 150. The control data block 162 stores control data, etc, for controlling the display with the indicator 10, in addition to character font data for ink character printing and braille font data for braille embossing. The user data block 163 stores input characters information (ink character data, etc.), braille information (characters information for braille, braille patterns, braille data, etc.) based on ink characters information, and braille modes as files.

The RAM 170 has, in addition to various work area blocks 171 used as a flag, etc., an ink-character printing data block 172 for storing generated ink character data which are expanded and a braille embossing data block 173 for expanding the generated braille data and storing braille embossing data expressing embossing/non-embossing at each of embossing points (71a, 71b, 71c, or 71d, 71e, 71f) in each of embossing columns. The RAM 170 is used as a work area for control processes. Further, the RAM 170 is always backuped for holding stored data in case of power failure.

The IOC 180 has logic circuits such as a gate array and a custom LSI (a pulse control LSI) incorporated therein for complementing functions of the CPU 150 and processes interface signals with various peripheral circuits. With this configuration, the IOC 180 sends input data or control data input via the keyboard 3 either with or without processing the same to the internal bus 190. In addition, the IOC 180 outputs to the driving section 130 data or control signals output to the internal bus 190 from the CPU 150 either with or without processing the same while cooperating with the CPU 150.

With the above configuration, the CPU 150 is input various signals/data from each section of the label forming apparatus 1 via the IOC 180 in accordance with the control programs of the ROM 160. Furthermore, the CPU 150 processes various data in the RAM 170 based on the set braille mode and input various signals/data, and outputs the various signals/data to each section of the label forming apparatus 1 via the IOC 180, thereby controlling the processes of the ink character printing process and the braille embossing process according to a designated process mode, and controlling the display with the indicator 10.

For example, when characters information is input by the user via the keyboard 3, the CPU 150 generates characters information for braille and braille patterns based on the set braille mode, and generates ink character data and braille data. Further, the CPU 150 expands the ink character data and the braille data in a state that they can be printed/embossed, and they are stored in the ink-character printing data block 172 and the braille embossing data block 173 temporarily. The above characters information and the braille information generated based on the characters information are stored in the user data block 163 of the ROM 160 as files including a braille mode at the time of generating the braille information.

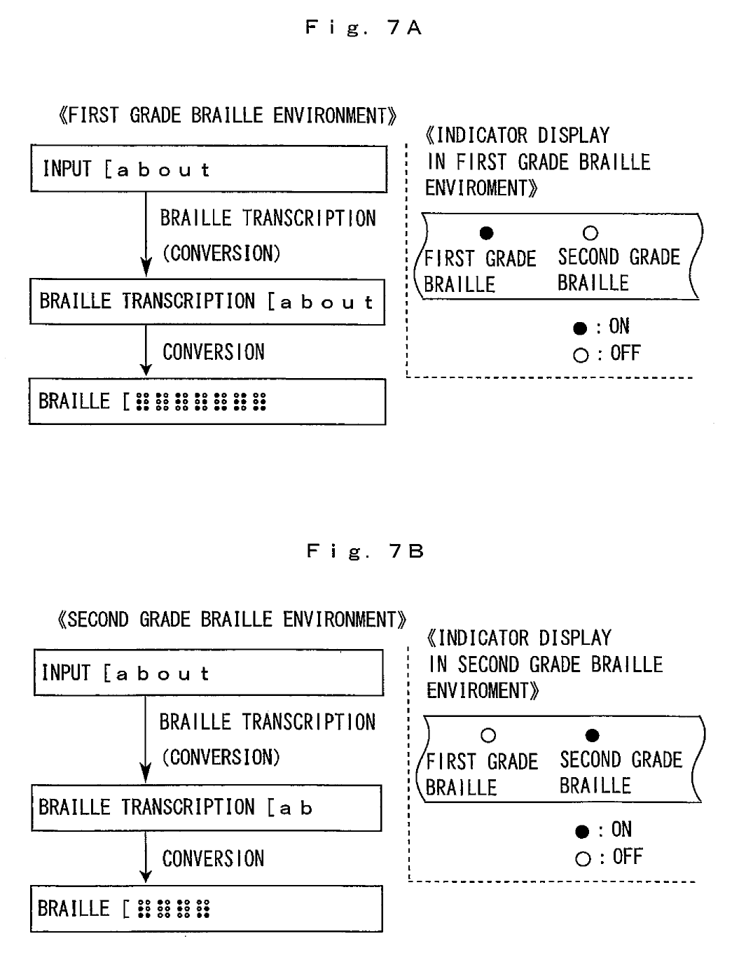

With reference to FIGS. 7A and 7B, an aspect of braille generated based on an input environment (the first grade braille mode or the second grade braille mode) will be explained. There are two input environments, namely, the first grade braille mode which converts characters information based on the first grade braille description processing rule (Grade 1) and generates braille patterns, and the second grade braille mode which converts the characters information based on the second grade braille description processing rule (Grade 2) and generates the braille patterns.

The first grade braille description processing rule is such that input one character (an alphabet) is described in a corresponding braille one cell. As shown in FIG. 7A, in the first grade braille mode, when a string of characters “about” is input in “an input” field, “about” of which each of the characters are converted based on the first grade braille description processing rule is displayed in “a braille transcription” field, and braille patterns corresponding to “a”, “b”, “o”, “u”, and “t” of the converted “about” are displayed in “a braille” field. Note that braille patterns displayed at both sides of “the braille” field mean foreign language quotation marks which show the braille is an English word therebetween. When the first grade braille mode is set, the first grade braille lamp 10a of the aforementioned indicator 10 is lit, thereby indicating that the set braille mode is the first grade braille mode.

On the other hand, the second grade Braille description processing rule is such that frequently used English words are described in contracted (abbreviated) forms. As shown in FIG. 7B, in the second grade Braille mode, when the string of characters “about” is input in “the input” field, “ab” are displayed in the braille transcription field, which are converted from the input character string (the English word) based on the second grade braille description processing rule and braille patterns corresponding to “a” and “b” of converted “ab” are displayed in the braille field. Thus, it is possible to reduce the number of braille cells by generating braille in the second grade braille mode. Note that the braille patterns at both sides of the braille field, as the first grade braille description processing rule, mean foreign language quotation marks. When the second grade braille mode is set, the second grade braille lamp 10b of the aforementioned indicator 10 is lit, thereby indicating that the set input environment is the second grade braille mode.

When the user depresses the aforementioned “braille environment key”, a Braille environment screen is displayed, in which the user can select the above mentioned first grade braille mode or the second grade braille mode and set therewith, making it possible to generate desired braille patterns. Also, in each of the braille modes, it is possible to store the input characters information and the braille information based on the characters information as files by a file storing device described later. Further, it is possible to call the stored files by a file calling device and to edit them.

The above indicator 10 indicates a current input environment by turning on either the first grade braille lamp 10a or the second grade braille lamp 10b, but it is also possible to arrange only one lamp to be on/off so as to distinctly indicate the first grade braille mode and the second grade braille mode. It is also possible to inform the set braille mode to the user by displaying characters information expressing the braille mode on the display 5, or to inform the set braille mode aurally to the user by generating different electronic sounds per braille mode.

Next, the file storing device (the file storing process) and the file calling device (the file calling process) will be explained. In the file storing process, the input characters information and the generated braille information based on the characters information are stored in the user data block 163 in the ROM 160 upon instruction from the user. At this time, information of the input environment (the first grade Braille mode or the second grade Braille mode, referred to as an individual Braille mode hereinafter) at the time of generating the Braille information is added, and these information is stored as one file. In storing, an individual number (file number) is added to each of the files which are stored. In file calling process described later, the file is called based on this number. Therefore, it is unnecessary to manage files per braille mode and is easy to manage files.

Note that, in the file storing process, it is possible to add information showing that a content of the file is generated with which braille mode is used together with the file number, making it possible to allow for the user to recognize visually if an objected file is generated in the first grade braille or the second grade braille.

In the file calling process, various information and the individual braille mode stored in the file are called by designating the file number added at the above file storing process by the user. The file calling process can be achieved by two methods. The first method is such that a current set braille mode (a braille mode set before the file calling) is changed and set to the individual braille mode called from the file (a braille mode setting device), and editing, etc., for the file is performed in the individual braille mode. The second method is such that editing, etc., for the file is performed based on the current set braille mode, regardless of the individual Braille mode called from the file. The above mentioned two methods may be set by user's selection with a mode setting, etc.

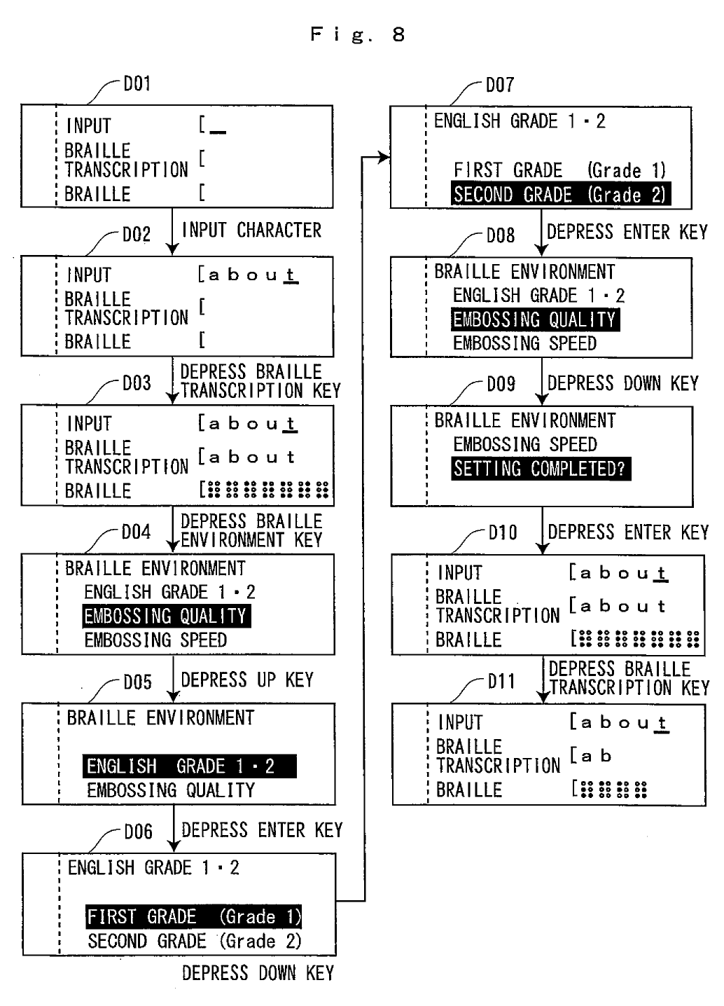

In the first method, various information called by the file calling process is displayed on the display 5 in an editable state, and the individual braille mode of the called file and the braille mode set before the calling are compared. When these modes are different each other, the braille mode is set to the individual braille mode. Thus, the user can operate editing, etc., for the file in the same mode in file creation. The set braille mode remains as it is till the file stored in a different individual braille mode is called, or till the user changes braille modes on the braille environment screen (see FIG. 8 (D04)) for setting the input environment (the braille mode).

In the second method, various information called by the file calling process is displayed on the display 5, and is in an editable state based on the set braille mode before calling, regardless of the individual braille mode of the file called. Then, the individual braille mode of the file called and the set braille mode before the calling are compared. When these modes are different each other, the individual braille mode of the file is changed to the set braille mode and overwrite saved. In case of editing, etc., the file by the user, a file editing operation based on the braille mode is indicated, then, the user needs to select to continue the editing operation in the different braille mode from that of the file creation time or to perform the editing operation in the same braille mode with that of the file creation time. In the former case, the file editing operation continues as it is, and the user can perform the editing operation consciously knowing only the braille mode set at the time. In the latter case, the user sets a desired braille mode on the braille environment screen again, and then the file editing operation is performed.

Referring to FIG. 8, procedures for changing and setting the input environment (the braille mode) according to a transition of screens displayed on the display 5. As shown in FIG. 8, the user turns the power on of the label forming apparatus 1, a character input screen (a text editing screen) is displayed (DO1). Here, “an input” field, “a transcription” field, and “a braille” field are displayed. The input field displays input character (characters information). The braille transcription field displays braille characters information in which the input character in the input field converted based on a set braille description processing rule. The braille field displays a braille pattern in which the braille characters information displayed in “the braille transcription” field is converted. A cursor K showing an input position is displayed in “the input” field. At this time, it is assumed that the input environment is set to the first grade braille mode and the first grade braille lamp 10a of the indicator 10 is lit.

In this state, the user depresses the characters information “a, b, o, u, t”, a string of characters “about” is displayed in “the input” field (DO2). When “the braille transcription” key is depressed, the braille characters information (the first grade braille characters information) “about” converted from each of the characters information “about” based on the braille description processing rule (the first grade braille description processing rule) of the set braille mode (the first grade braille mode) and the first braille patterns converted from the braille characters information are generated, and are displayed in “the braille transcription” field and “the braille” field on the screen, respectively (DO3).

Next, in the above state (DO3), when the user depresses “the braille environment key” to change the current set first grade braille mode to the second grade braille mode, a braille environment screen is displayed (DO4). This screen has alternatives including “an English 1•2 grade” for setting the braille mode, “an embossing qualification” for setting a qualification of embossing, “an embossing speed” for setting an embossing speed of the braille embossing, and “a setting completed ?” for reflecting the settings above. The user can select with “the up/down keys” and “the left/right keys” on the keyboard 3.

In the screen (DO4), when the user depresses “the up key” to select “the English 1•2 grade”, it is highlighted (D05). Then, “the decision key (the selection line break key)” is depressed, and a screen for changing the braille environment settings is displayed (DO6). In the screen (DO6) showing “the English 1•2 grade” for setting the braille mode, “the first grade (Grade 1)” for setting the input environment to the first grade braille mode or “the second grade (Grade 2)” for setting to the second grade braille mode can be selected (an input environment setting device). The input environment is set to the first grade braille mode as described above, and “the first grade (Grade 1)” is highlighted. When the user depresses “the down key” to set to the second grade braille mode, the selected “second grade (Grade 2)” is highlighted (DO7). Then, “the decision key” is depressed to make certain that the second grade braille mode has been selected, and the braille environment screen is returned (DO8). Further, “the down key” is depressed, “the setting completed ?” is highlighted (DO9). After “the decision key” is depressed (the input environment setting device), the current input environment is set to the second grade braille mode, and the text editing screen comes back (DO10).

Note that, in the above state (DO10), the input environment is set to the second grade braille mode, but the braille characters information and the braille patterns on the screen are not converted based on the second grade braille description processing rule, and are still displayed with the first grade Braille description processing rule. Then, only after “the braille transcription key” is depressed (a braille pattern transcription device), they are converted based on the second grade braille description processing rule, and the second grade braille characters information and the second grade braille patterns are displayed in “the braille transcription” field and “the braille” field, respectively (D11). In the time of D10, the second grade braille lamp 10b of the indicator 10 is on and the first grade braille lamp 10a thereof is off.

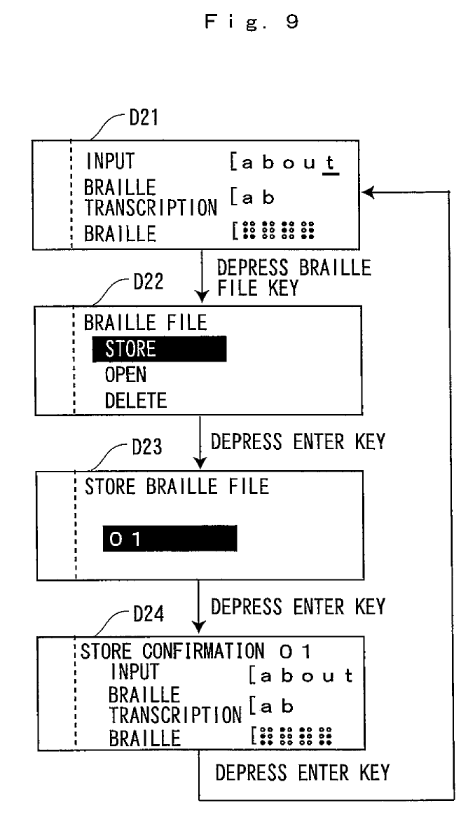

Referring to FIG. 9, file storing procedures according to a transition of screens displayed on the display 5 will be explained. Procedures for storing the characters information converted based on the above described second grade braille description processing rule, the braille information and the input environment information (the information of the second grade braille mode) (FIG. 8 (D11)) will be explained. Therefore, the input environment is set to the second grade braille mode.

As shown in FIG. 9, when “a braille file key” is depressed with a state that the characters information, braille characters information and braille patterns generated described above are displayed (D21), a braille file screen is displayed (D22). The braille file screen has alternatives including “a storage” which stores various information in a file, “a call” which calls the stored file, and “a purge” which purges the stored file, which can be selected with “the up/down (left/right) key)”. When “the storage” selected by the user is highlighted, and “the decision key” is depressed, the braille file storage screen is displayed (D23). In the braille file storage screen, an objected file to be stored is numbered with a reference number (a file number) automatically, and the file is managed, etc., based on the file number. Then “the decision key” is depressed, a storage confirmation screen is displayed (D24), in which the file number and the objected information to be stored (the information in D21) are displayed for confirmation. “The decision key” is depressed again, file storage is completed and the initial screen (D21) is returned.

In the case of the above, as the storage for the input environment information (the information of the second grade braille mode) is performed without letting the user know, information regarding the input environment is not displayed on the screen. However, it is possible to display a type (the first grade braille mode or the second grade braille mode) of the input environment of braille to be stored on the braille file storage screen (D23), etc.

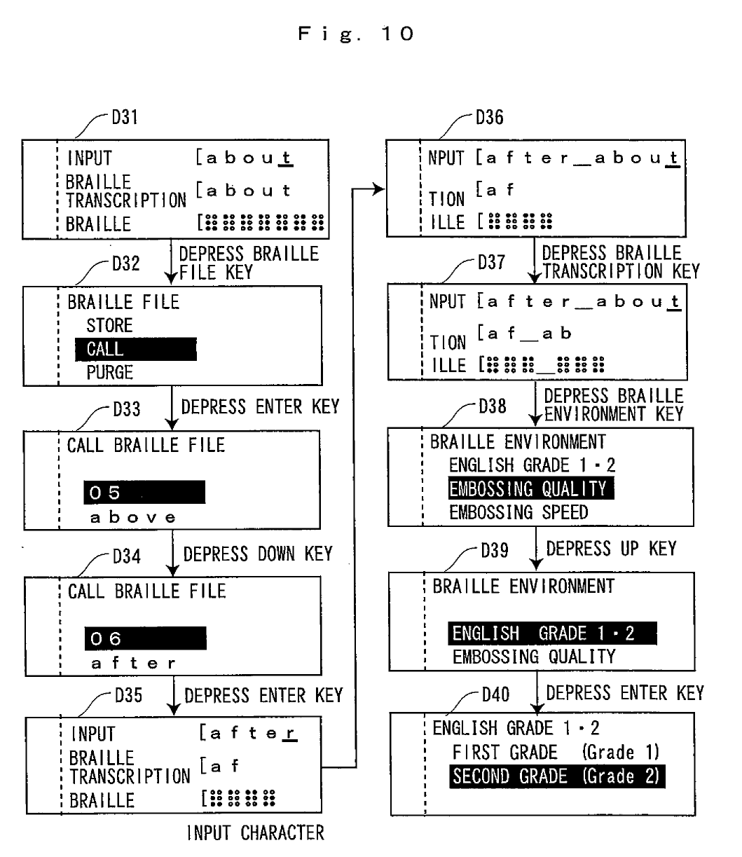

Referring to FIG. 10, file calling procedures with the first method according to a transition of screens displayed on the display 5 will be explained. The input environment is set to the first grade braille mode, and input characters information (about), braille characters information (about) converted based on the first grade braille description processing rule and braille patterns are displayed on a screen (D31). At this time, the first grade Braille lamp 10a of the indicator 10 is on and the second Braille lamp 10b thereof is off. In this state, when “the braille file key” is depressed by the user to call the stored file, a braille file screen is displayed (D32). In the braille file screen, as described above, alternatives, which are “the storage”, “the call” and “the purge” can be selected. When “the call” selected by the user is highlighted and “the decision key” is depressed, a braille file calling screen is displayed (D33).

In the braille file calling screen, files already stored are displayed in file numerical order and the user can select with “the up/down (left/right) key”. At the lower side of the file number, characters information (information displayed in “the input” field) in the stored various information is displayed. The user can confirm the contents of the file to be called herewith. When the user depresses “the down key” and selects an objected file (a file storing information “after”) with the file number 06 to be called, the file number is highlighted (D34). When the user depresses “the decision key”, the contents of the file number 06 are displayed on the screen (D35). Concurrently with this calling process, the initial input information (D31) is purged.

The file (D35) displayed on the screen is such that a braille characters information “af” converted based on the second grade braille description processing rule and braille patterns are generated on a basis of characters information “after”. In other words, the individual braille mode of the file is set to the second grade braille mode, which is different from the braille mode (the first grade braille mode) before file calling. At this point, the braille mode (the first grade braille mode) before file calling is changed to the second grade braille mode (the individual braille mode). At this time, the second grade braille lamp 10b of the indicator 10 is on and the first grade braille lamp 10a thereof is off. Therefore, characters information “about” is newly inserted after the already input “after” (D36). When the user depresses “the braille transcription key”, the characters information “after_about” (under bar means a space) is converted based on the second grade braille description processing rule, and “af_ab” is displayed in “the braille transcription” field and the second grade braille patterns are displayed in “the braille” field (D37).

In this state (D37), when the user depresses “the braille environment key” to confirm the input environment (the Braille mode), a braille environment screen is displayed (D38) and “an English 1•2 grade” selected by the user is highlighted (D39). Further, “the decision key” is depressed, “the English 1•2 grade” screen with “the second grade (Grade 2)” highlighted is displayed (D40). By these procedures, it is possible to confirm that the current input environment (the braille mode) is changed to the individual braille mode (the second grade braille mode) of the file called and the second grade braille mode is set.

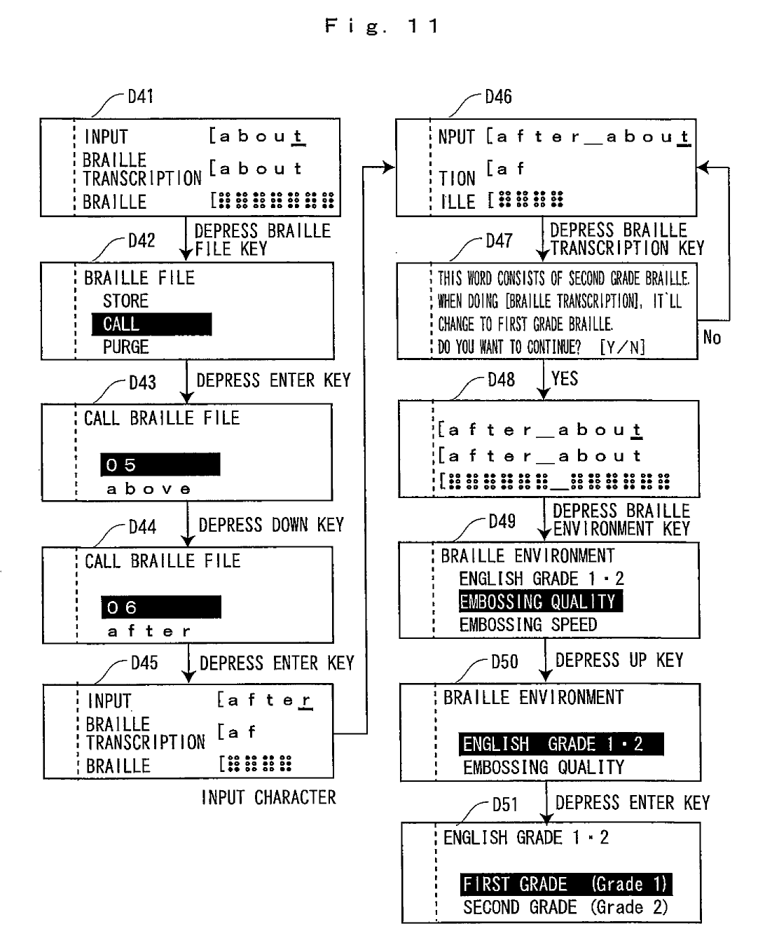

Referring to FIG. 11, file calling procedures with the second method according to a transition of screens displayed on the display 5 will be explained. The input environment is set to the first grade braille mode, and input characters information (about), braille characters information (about) converted based on the first grade braille description processing rule and braille patterns are displayed on a screen (D41). At this time, the first grade braille lamp 10a of the indicator 10 is on and the second grade braille lamp 10b thereof is off. In this state, when “the braille file key” is depressed to call a file stored, a braille file screen is displayed (D42) In the braille file screen, as described above, alternatives, which are “a storage”, “a call” and “a purge” can be selected. When “the call” selected by the user is highlighted and “the decision key” is depressed, a braille file calling screen is displayed (D43).

In the braille file calling screen, files already stored are displayed in file numerical order and the user can select with “the up/down (left/right) key”. At the lower side of the file number, characters information (information displayed in “the input” field) in the stored various information is displayed. The user can confirm the contents of the objected file to be called herewith. When the user depresses “the down key” and selects the objected file (file storing information “after”) with the file number 06 to be called, the file number is highlighted (D44). When the user depresses “the decision key”, the contents of the file number 06 are displayed on the screen (D45). Concurrently with this calling process, the initial input information (D41) is purged.

The file (D45) displayed on the screen is such that a braille characters information “af” converted based on the second grade braille description processing rule and braille patterns are generated on a basis of characters information “after”. In other words, an individual braille mode of the file is set to the second grade braille mode, which is different from the braille mode (the first grade braille mode) before file calling. Therefore, the individual braille mode (the second grade braille mode) is changed to the first grade braille mode (the braille mode before file calling), and overwrite saved in the file. The input environment (the braille mode) remains as the first grade braille environment, the first grade braille lamp 10a of the indicator 10 is on and the second grade braille lamp 10b thereof is off. At this time, characters information “about” is newly inserted after the input “after” (D46). When the user depresses “the braille transcription key”, a warning display screen is displayed (P47) so as to urge the user to determine if the contents displayed on the screen in the second grade braille can be converted based on the first grade braille mode (the current set braille mode) (D47).

When the user selects “Yes” which allows the displayed contents on the screen to be edited (editing device) based on the first grade braille description processing rule (the first grade braille mode), “after_about” is converted based on the first grade braille description processing rule, and “after_about” and the corresponding first grade braille patterns are displayed in “the braille transcription” field and “the braille” field, respectively (D48). On the other hand, when the user selects “No”, the editing screen (D46) is returned, which is the screen before “the braille transcription key” is pressed. At this time, when the user wants to continue the editing operation with the second grade braille, the user has to select and set “the second grade (Grade 2)” on the braille environment screen based on a change setting procedure for the input environment as described above to continue the editing operation.

In the state (D48) in which the above described “Yes” is selected, when “the braille environment key” is depressed to confirm the input environment (the braille mode), a braille environment screen is displayed (D49) and “an English 1•2 grade” selected by the user is highlighted (D50). Further, when “the decision key” is depressed, “the English 1•2 grade” screen with “the first grade (Grade 1)” is highlighted is displayed (D51). With this procedure, the current input environment (the braille mode) remains in the first grade braille mode, and the user can confirm that the current input environment has not changed regardless of the individual braille mode of the file called.

As described above, according to the embodiment, it is possible to convert the input characters information into the Braille pattern automatically based on the braille description processing rules corresponding to the respective braille modes by setting the input environment with a selection of either the first grade braille mode or the second grade braille mode. Therefore, even the user having little understanding of braille can properly use the first grade braille and the second grade braille easily and desired Braille can be formed. Also, by indicating the set braille mode, the user can discriminate easily whether the current braille mode is the first grade braille mode or the second grade braille mode.

As a braille mode at the time of file creation is stored as an individual braille mode, it is not necessary to manage the files per braille mode distinctly, thereby a file management is easily performed. Further, on file calling, it is possible to edit, etc., for the file in the same mode as the previously used mode without understanding the individual braille mode of the file called (the first embodiment).

Also, it is possible to provide programs which cause each section of the label forming apparatus 1 to function to a computer. Further, it is possible to provide the programs which are stored in a memory medium (not shown). As the memory medium, a CD-ROM, a flash ROM, a memory card (a Compact Flash™), a smart media, a memory stick, etc), a compact disc, a magnet-optical disc, a digital versatile disc, and a flexible disc, etc, can be used.

Also, in place of the embodiment described above, it is possible to modify an apparatus configuration or process procedures, etc, of the label forming apparatus 1 without departing from a summary of the invention. The invention can be applied to any apparatus which can emboss braille in addition to the label forming apparatus 1.

What is claimed is:

1. A braille-information processing apparatus comprising:
a braille pattern converting device that converts input character information into a braille pattern based on a first grade braille description processing rule or a second grade braille description processing rule; and
an input environment setting device that sets an input environment to a first grade braille mode based on the first grade braille description processing rule or a second grade braille mode based on the second grade braille description processing rule,
wherein the braille pattern converting device converts the input character information into a first grade braille pattern based on the first grade braille description processing rule when the input environment is set to the first grade braille mode, and converts the input character information into a second grade braille pattern based on the second grade braille description processing rule when the input environment is set to the second grade braille mode.

2. The braille-information processing apparatus according to claim 1, further comprising an indicating device that indicates the braille mode set by the input environment setting device.

3. The braille-information processing apparatus according to claim 2, further comprising:
a file storing device that stores a file including the character information and braille information generated based on the character information in a storage unit; and
a file calling device that calls the file stored in the storage unit,
wherein the file storing device further stores the braille mode at the time of file creation as an individual braille mode, together with the file.

4. The braille-information processing apparatus according to claim 3, further comprising a braille mode setting device that changes the braille mode to the individual braille mode to set when the individual braille mode of the file called by the file calling device is different from the braille mode set before calling for the file.

5. The braille-information processing apparatus according to claim 3, further comprising an editing device that edits the file called by the file calling device,
wherein the editing device edits the file based on the braille mode set before calling for the file, regardless of the individual braille mode of the file called, and
the file storing device changes the individual braille mode of the file to the set braille mode to store when the individual braille mode of the file called by the file calling device is different from the braille mode set before calling for the file.

6. The braille-information processing apparatus according to claim 4, wherein there is indicated that the individual braille mode is different from the set braille mode or that the braille mode is changed, when the individual braille mode of the file called by the file calling device is different from the braille mode set before calling the file.

7. A method of controlling a braille-information processing apparatus which converts input character information into a braille pattern comprising:
an input environment setting that sets an input environment to a first grade braille mode in which the input environment is converted to the braille pattern based on a first grade braille description processing rule or a second grade braille mode in which the input environment is converted to the braille pattern based on a second grade braille description processing rule; and
a braille pattern converting that converts the input character information into a first grade braille pattern based on the first grade braille description processing rule when the input environment is set to the first grade braille mode, and that converts the input character information into a second braille pattern based on the second grade braille description processing rule when the input environment is set to the second grade braille mode.

8. A braille forming apparatus comprising:
each of the devices in the braille-information processing apparatus according to claim 1; and
a braille embossing device that braille embosses based on the braille pattern converted by the braille pattern converting device.
